(19) United States
(12) Patent Application Publication
(10) Pub. No.: US 2009/0022953 A1
(43) Pub. Date: Jan. 22, 2009

(54) DIFFUSION BRIGHTNESS ENHANCEMENT SHEET

(76) Inventors: Yaw-Huei Tsai, Taipei County (TW); Ming-Hsuan Liu, Taipei County (TW); Yi-Rong Qiu, Taipei County (TW)

Correspondence Address: BIRCH STEWART KOLASCH & BIRCH, PO BOX 747, FALLS CHURCH, VA, 22040-0747, US

(21) Appl. No.: 12/023,962

(22) Filed: Jan. 31, 2008

(30) Foreign Application Priority Data
Jul. 19, 2007 (TW) 096126439

(51) Int. Cl. B32B 33/00

(52) U.S. Cl. 428/148; 428/141; 428/149

(57) ABSTRACT

A diffusion brightness enhancement sheet includes a substrate and a prism structure. The substrate has a first surface and a second surface, which are disposed opposite to each other The substrate has a diffusion material, and the prism structure is disposed over the second surface.

### CROSS REFERENCE TO RELATED APPLICATIONS

This Non-provisional application claims priority under 35 U.S.C. §119(a) on Patent Application No(s). 096126439 filed in Taiwan, Republic of China on Jul. 19, 2007, the entire contents of which are hereby incorporated by reference.

### BACKGROUND OF THE INVENTION

1. Field of Invention

The invention relates to an optical sheet and, in particular, to an optical sheet with diffusion and brightness enhancement functions.

2. Related Art

The backlight module is an important component of the liquid crystal device (LCD). Since the liquid crystal does not emit light, the backlight module functions as a uniform surface light source to provide sufficient brightness for the LCD panel.

As shown in FIG. 1, a conventional backlight module 1 includes a light source 10, a light guide plate 11, and an optical sheet set 12. The backlight module 1 is a side-edge backlight module. The light source 10 can be a cold cathode fluorescent lamp (CCFL) or several light-emitting diodes (LEDs).

The optical sheet set 12 includes in sequence a lower diffusion sheet 121, a first prism sheet 122, a second prism sheet 123, and an upper diffusion sheet 124 stacked together. The optical sheet set 12 is disposed on the light guide plate 11.

The light (not shown) emitted by the light source 10 enters the light guide plate 11, and then the mesh points on the bottom surface of the light guide plate 11 destroy the total reflection of the incident light. The light then enters the optical sheet set 12. In the optical sheet set 12, the light firstly passes through the lower diffusion sheet 121 for preliminary diffusion. Then, the light passes through the first prism sheet 122 and the second prism sheet 123 to increase its brightness. Finally, the upper diffusion sheet 124 further diffuses the outgoing light, so that the user does not directly see the Moire pattern on the prism sheets. The upper diffusion sheet 124 also has the function of protecting the second prism sheet 123. Therefore, the backlight module 1 provides uniform light with higher brightness in the normal direction.

However, the optical sheet set 12 involves many sheets, which inevitably increases the production cost of the backlight module 1. Therefore, it is an important subject to provide an optical sheet that can simplify the backlight module structure, reduce the production cost and increase the uniformity and brightness in the normal direction of the light.

### SUMMARY OF THE INVENTION

In view of the foregoing, the invention is to provide a diffusion brightness enhancement sheet that can decrease the number of optical sheets used in the backlight module and thus reduces the production cost.

To achieve the above, the invention discloses a diffusion brightness enhancement sheet, which includes a substrate and a prism structure. The substrate includes a diffusion material. The substrate has a first surface and a second surface disposed opposite to each other. The prism structure is disposed over the second surface.

To achieve the above, the invention also discloses a diffusion brightness enhancement sheet, which includes a substrate and a prism structure. The substrate has a first surface and a second surface disposed opposite to each other. The first surface and/or the second surface are a rough surface. The prism structure is disposed over the first surface and/or the second surface.

As mentioned above, the diffusion brightness enhancement sheet of the invention combines diffusion materials or rough surfaces and the prism structure on the same substrate. In comparison with the related art, the combination of the diffusion sheet and the brightness enhancement sheet allows the light of the backlight module to pass only a single diffusion brightness enhancement sheet. This homogenizes the source light and increases the brightness in the normal direction. Accordingly, the Moiré pattern on the LCD can be decreased. Moreover, the number of optical sheets is fewer to simplify the structure of the backlight structure, thereby reducing the production cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional backlight module and its optical sheet set;

FIG. 2 is a schematic view of a diffusion brightness enhancement sheet according to a first embodiment of the invention;

FIGS. 3 and 4 show variations of the diffusion brightness enhancement sheet according to the first embodiment of the invention;

FIG. 5 is a schematic view of a diffusion brightness enhancement sheet according to a second embodiment of the invention;

FIG. 6 is a schematic view of another diffusion brightness enhancement sheet according to the second embodiment of the invention;

FIG. 7 is a schematic view of a diffusion material of the invention;

FIG. 8 is a schematic view of a diffusion brightness enhancement sheet according to a third embodiment of the invention;

FIG. 9 is a schematic view of another diffusion brightness enhancement sheet according to the third embodiment of the invention;

FIG. 10 is a schematic view of a diffusion brightness enhancement sheet according to a fourth embodiment of the invention; and

FIG. 11 is a schematic view of a diffusion brightness enhancement sheet according to a fifth embodiment of the invention.

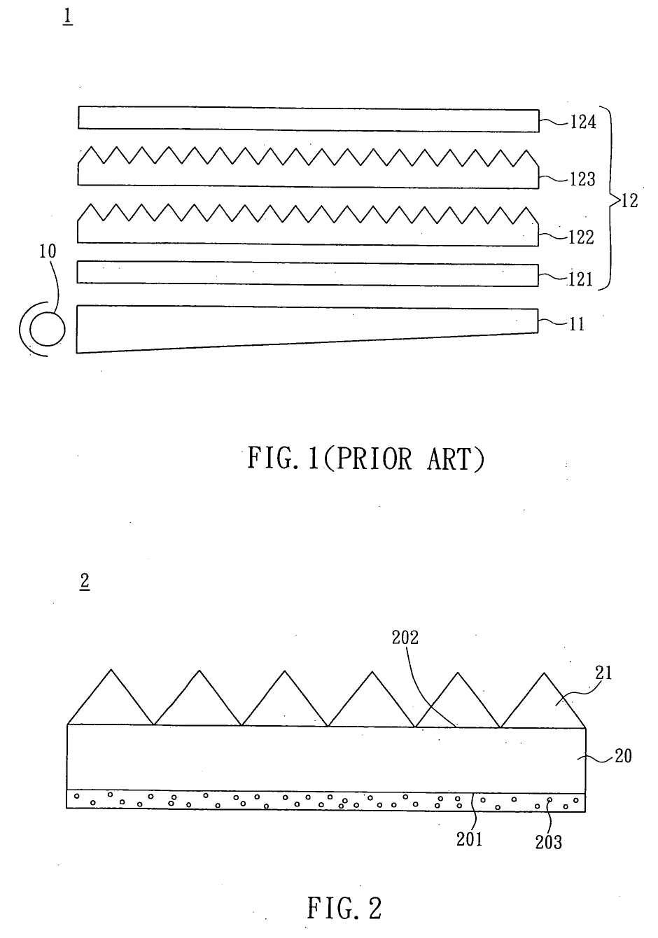

### DETAILED DESCRIPTION OF THE INVENTION

The present invention will be apparent from the following detailed description, which proceeds with reference to the accompanying drawings, wherein the same references relate to the same elements.

### First Embodiment

With reference to FIG. 2, a diffusion brightness enhancement sheet 2 according to a first embodiment of the invention includes a substrate 20 and a prism structure 21. The diffusion brightness enhancement sheet 2 can be disposed in a backlight module.

The substrate 20 has a first surface 201 and a second surface 202 disposed opposite to each other. The material of the substrate 20 is transparent polyethylene terephthalate (PET) or polycarbonate. The substrate 20 includes a diffusion material 203, which is disposed on the first surface 201. In this embodiment, the diffusion material 203 consists of diffusion particles, such as titanium dioxide silicon dioxide, PMMA, glass or plastic, which are mixed with a binder so as to be disposed on the first surface 201. Of course, the diffusion material 203 can include only the diffusion particles, which are disposed on the first surface 201 using some other method, such as spraying. To be noted, in order to make the light diffusion effect much better, the size of the diffusion particles is smaller than 50 micrometers. The difference between the refraction indexes of the diffusion material 203 and the binder/substrate 20 is larger than 0.01 so as to enhance the diffusion effect. In the embodiment, the diffusion particles can be transmissive diffusion particles, which are light permeable and can change the light path based on the refraction index variations. Alternatively, the diffusion particles can also be scattering diffusion particles, which are not light permeable and can change the light path by the particle surfaces.

The prism structure 21 is disposed over the second surface 202. In the embodiment, the prism structure 21 can be a triangular prism or other shapes of prism that can enhance the brightness in the normal direction. Since the prism structure 21 is not the essence of the invention, it is not further described herein.

The source light of the backlight module enters the diffusion brightness enhancement sheet 2 via the side formed with the diffusion material 203, which can scatter the light. Therefore, when the light passes through the prism structure 21, the brightness in the normal direction can be enhanced. Accordingly, the diffusion brightness enhancement sheet 2 can simultaneously increase the uniformity and brightness of the light source in the normal direction.

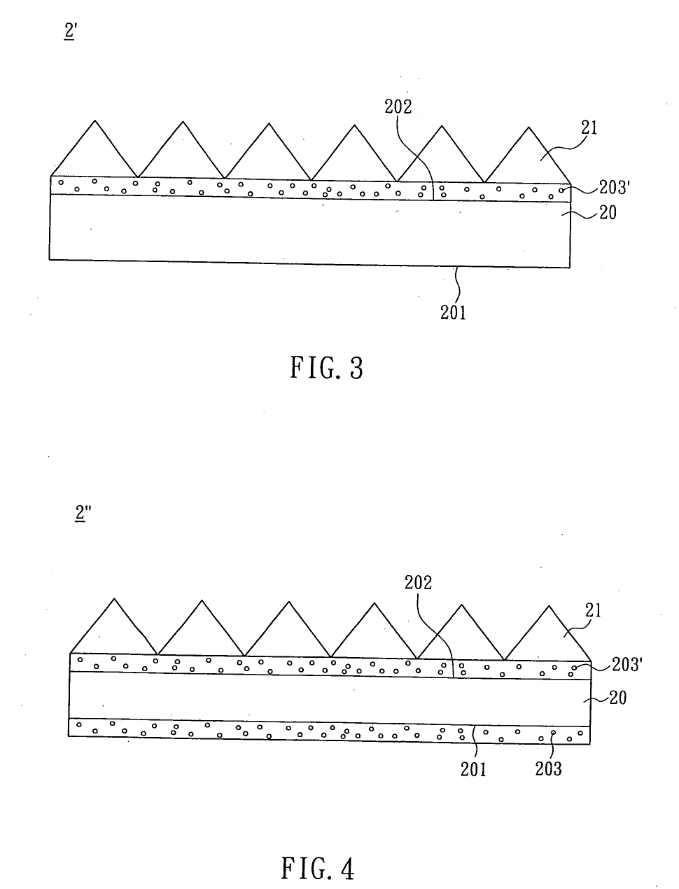

Referring to FIGS. 3 and 4, the diffision material can have different arrangements. As shown in FIG. 3, the diffusion material 203′ in the diffusion brightness enhancement sheets 2′ is disposed between the prism structure 21 and the second surface 202. Alternatively, as shown in FIG. 4, the diffusion materials 203 and 203′ can be disposed on the first surface 201 and the second surface 202, respectively. The prism structure 21 is disposed on the diffusion material 203′, so that the light passes through the diffusion materials 203 and 203′ and the prism structure 21, thereby enhancing the uniformity and brightness of the light in the normal direction.

### Second Embodiment

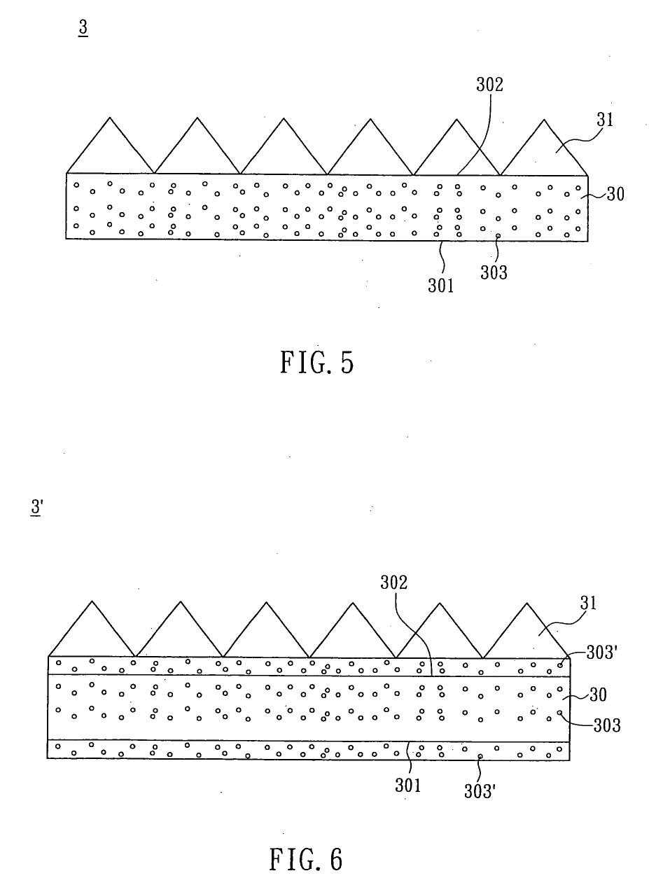

As shown in FIG. 5, a diffusion brightness enhancement sheet 3 according to a second embodiment of the invention includes a substrate 30 and a prism structure 31. The substrate 30 has a first surface 301 and a second surface 302, which are disposed opposite to each other. The prism structure 31 is disposed over the second surface 302. In this embodiment, the diffusion material 303 is directly mixed into the substrate 30 by doping or mixing. The difference between the refraction index of the substrate 30 and that of the substrate 30 doped with the diffusion material 303 is larger than 0.01, thereby enhancing the diffusion effect. To be noted, the refraction index of the substrate 30 can be larger than or less than that of the diffusion particles 303.

In addition to doping the diffusion material 303 into the substrate 30, another diffusion material 303′ can be further disposed on the first surface 301 and/or the second surface 302 of the diffusion brightness enhancement sheet 3′. As shown in FIG. 6, the diffusion material 303 is doped into the substrate 30 and the diffusion material 303′ is simultaneously disposed on the first surface 301 and the second surface 302.

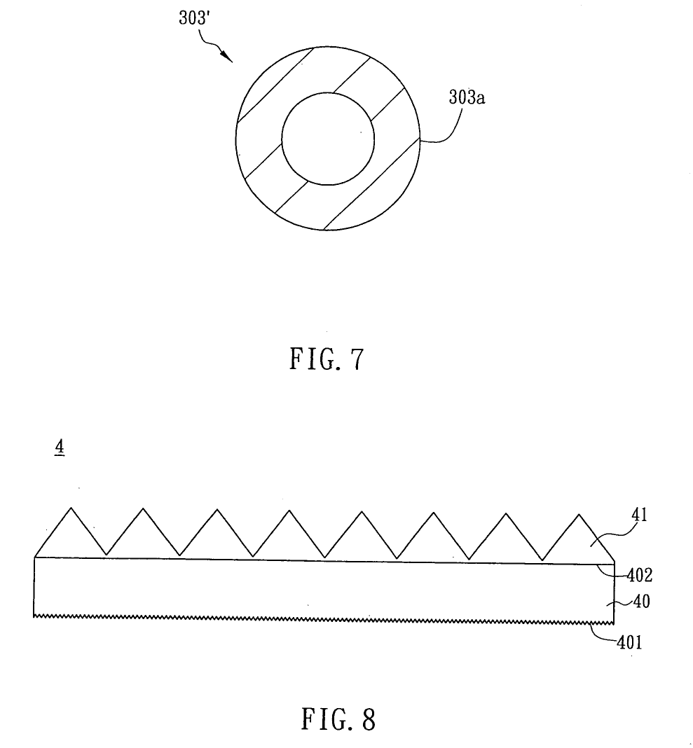

With reference to FIG. 7, the diffusion material 303′ can have a multi-layers structure. For example, the diffusion material 303′ has an outer film 303a made of acryl, silicon gel or epoxy. The outer film 303a covers a single or multiple materials, such as titanium dioxide, silicon dioxide, PMMA, glass, plastic, or air.

### Third Embodiment

As shown in FIG. 8, a diffusion brightness enhancement sheet 4 according to a third embodiment of the invention includes a substrate 40 and a prism structure 41. The substrate 40 has a first surface 401 and a second surface 402 disposed opposite to each other. In the embodiment, the first surface 401 is a rough surface, such as a surface processed by abrasive blasting or some chemical agent. The prism structure 41 is disposed on the second surface 402. When the source light passes through the first surface 401, the rough surface scatters it to produce uniform light.

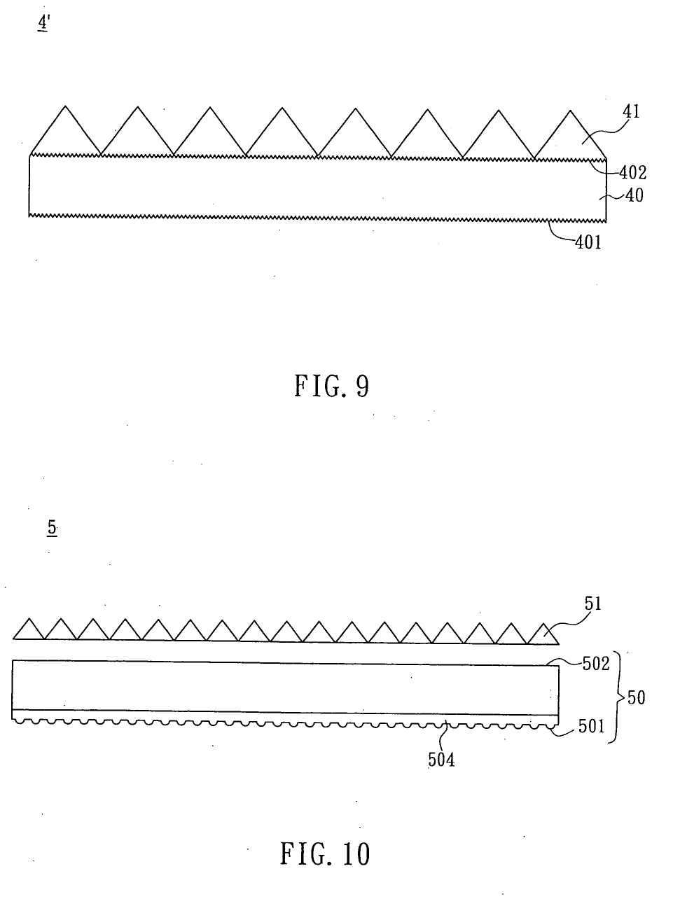

In addition to the first surface 401 being rough, the second surface 402 or both the first and second surfaces 401 and 402 can be rough as well. As shown in FIG. 9, the first surface 401 and the second surface 402 of the diffusion brightness enhancement sheet 4′ are both rough surfaces. The prism structure 41 is disposed on the second surface 402.

### Fourth Embodiment

As shown in FIG. 10, a diffusion brightness enhancement sheet 5 according to a fourth embodiment of the invention includes a substrate 50 and a prism structure 51. The substrate 50 has a first surface 501 and a second surface 502 disposed opposite to each other. The prism structure 51 is disposed over the second surface 502.

In this embodiment, the substrate 50 further includes a diffusion sub-layer 504. The rough surface is formed on the diffusion sub-layer 504, and is disposed on the first surface 501 of the substrate 50. The diffusion sub-layer 504 has concave and convex surfaces (like a micro lens array). They can be formed by ultraviolet (UV) curing so as to process the first surface 501 of the substrate 50 as a rough surface for scattering light. It should be noted that the material of the diffusion sub-layer 504 and that of the substrate 50 can be the same or different.

### Fifth Embodiment

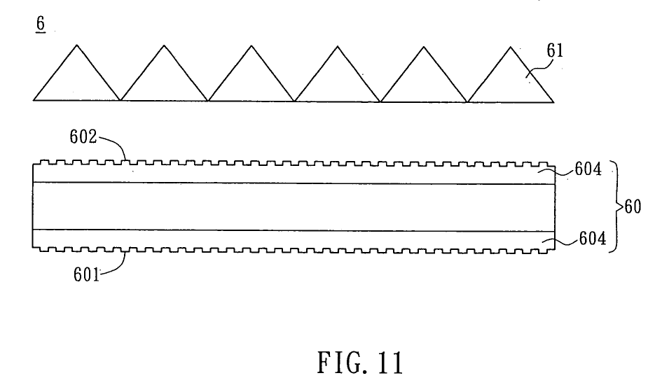

With reference to FIG. 11, a diffusion brightness enhancement sheet 6 according to a fifth embodiment of the invention includes a substrate 60, a prism structure 61, and a matte paper 604. The matte paper 604 serves as the rough surfaces on the first surface 601 and/or the second surface 602. In this embodiment, the matte paper 604 is disposed on both the first surface 601 and the second surface 602 of the substrate 60 to form the rough surfaces for scattering light. The prism structure 61 is disposed on the matte paper 604.

In summary, the diffusion brightness enhancement sheet of the invention combines diffusion materials or rough surfaces and the prism structure on the same substrate. In comparison with the related art, the combination of the diffusion sheet and the brightness enhancement sheet allows the light of the backlight module to pass only a single diffusion brightness enhancement sheet. This homogenizes the source light and increases the brightness in the normal direction. Accordingly, the Moiré pattern on the LCD can be decreased. Moreover, the number of optical sheets is fewer to simplify the structure of the backlight structure, thereby reducing the production cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A diffusion brightness enhancement sheet, comprising:
a substrate, which has a first surface and a second surface disposed opposite to each other, wherein the substrate comprises a diffusion material; and
a prism structure, which is disposed over the second surface.

2. The diffusion brightness enhancement sheet of claim 1, wherein the material of the substrate is polyethylene terephthalate (PET) or polycarbonate.

3. The diffusion brightness enhancement sheet of claim 1, wherein the diffusion material is disposed on the first surface and/or the second surface.

4. The diffusion brightness enhancement sheet of claim 1, wherein the diffusion material is doped or mixed in the substrate.

5. The diffusion brightness enhancement sheet of claim 3, wherein the diffusion material comprises a plurality of diffusion particles selected from the group consisting of titanium dioxide, silicon dioxide, PMMA, glass, plastic, and/or air.

6. The diffusion brightness enhancement sheet of claim 5, wherein the diffusion particle has an outer sheet made of acryl, silicon gel or epoxy.

7. The diffusion brightness enhancement sheet of claim 1, wherein a difference between refraction indexes of the diffusion material and the substrate is larger than 0.01.

8. A diffusion brightness enhancement sheet, comprising:
a substrate, which has a first surface and a second surface disposed opposite to each other, wherein the first surface and/or the second surface is a rough surface; and
a prism structure, which is disposed over the first surface and/or the second surface.

9. The diffusion brightness enhancement sheet of claim 8, wherein the material of the substrate is polyethylene terephthalate (PET) or polycarbonate.

10. The diffusion brightness enhancement sheet of claim 8, wherein the substrate has a diffusion sub-layer, and the rough surface is formed on the diffusion sub-layer and disposed on the first surface.

11. The diffusion brightness enhancement sheet of claim 8, wherein the rough surface is processed by abrasive blasting or a chemical agent.

12. The diffusion brightness enhancement sheet of claim 8, wherein the substrate has a matte paper formed on the first surface and/or the second surface.
